(19) United States
(12) Patent Application Publication
(10) Pub. No.: US 2021/0015072 A1
(43) Pub. Date: Jan. 21, 2021

(54) CLEANING OF A FRONT OF AN OPTICAL INSTRUMENT OF A MILKING PARLOR

(71) Applicant: GEA Farm Technologies GmbH, Bönen (DE)

(72) Inventor: Magnus Wiethoff, Welver (DE)

(21) Appl. No.: 16/947,082

(22) Filed: Jul. 17, 2020

(30) Foreign Application Priority Data
Jul. 19, 2019 (DE) 10 2019 119 661.2

(51) Int. Cl. A01J 7/02; A01J 5/007

(52) U.S. Cl. CPC A01J 7/02; A01J 5/007

(57) ABSTRACT

An arrangement and a corresponding method for cleaning a front of an optical instrument using a movable cap for directing a cleaning fluid to the front of the optical instrument.

### CROSS REFERENCE TO RELATED APPLICATION

This application claims priority to German Application No. 10 2019 119 661.2 filed on Jul. 19, 2019, the disclosure of which is incorporated by reference herein.

### FIELD AND BACKGROUND OF THE INVENTION

The invention relates to an arrangement comprising at least one milking parlor, which has an optical instrument, and an apparatus for cleaning a front of the optical instrument by means of a fluid. In particular, the arrangement according to the invention may be designed and provided for cleaning a lens or protective cover of a lens of a camera which is arranged in a milking parlor.

Animals are currently typically milked with the aid of machines. For mechanical and automated milking of for example a cow, a milking parlor in which the milking equipment is fully automatically placed onto the animal after the animal has entered the milking parlor is known. The milking parlor has lateral boundaries, and also a boundary at the head end, such that the animal enters the milking parlor and stands still there during the milking operation. The invention will be described below with a cow as the animal to be milked, this being given as a representative example for any other kind of animal which is able to be milked.

The milking parlor has for this purpose milking equipment with teat cups, wherein the milking parlor is set up for precise placement of the teat cups of the milking equipment. The milking parlor or the milking robot of the milking parlor is accordingly provided and set up for determining the exact position of the animal to be milked and in particular the exact position of the teats of the animal, onto each of which teats a milking cup is to be placed. Here, the milking cups are placed one after the other and in each case such that the milking cup exactly meets the position of the teat.

The position of a teat is for this purpose determined in an automated manner, and subsequently the milking cup provided for a teat is correspondingly positioned on the teat by means of a movable arm. For the purpose of determining the position of a teat in an automated manner, the milking robot or the milking parlor has an optical device which produces images of the animal and in particular of the udder and the teats and which is set up and provided for determining the exact position of the teats. The optical device is typically provided and set up for processing and evaluating the produced images of the animal by means of a processing program, such that the exact position of the teats is known. For this purpose, the milking robot may comprise a digital signal processor and memory with a computer program for digital image processing, and is communicatively connected to the optical device, with the result that the milking robot can control the production of images and can subsequently process and evaluate the images produced in order to determine the position of the individual teats.

The optical instrument for producing the images, that is to say for example a camera, is arranged in the milking parlor or the milking robot so as to be able to produce an image of the animal udder and of the teats. Typically, for this purpose, the camera is arranged in the vicinity of the base of the milking parlor and in the vicinity of the udder.

This gives rise to the problem that the optical apparatus can be soiled and the images produced can therefore be unusable. Although the milking parlor and the milking equipment are cleaned at regular intervals, cleaning residues can remain on the optical apparatus. This gives rise to the technical problem that, before the beginning of the procedure of placement of the milking cups, it has to be ensured that the optics of the optical apparatus are not soiled.

### SUMMARY OF THE INVENTION

The problem is solved by way of an arrangement comprising at least one milking parlor, which has an optical instrument, and an apparatus for cleaning a front of the optical instrument by means of a fluid, or is, by way of said arrangement, at least fixed to such an extent that usable images are generated.

The expression “front of an optical instrument” refers in this context to a front side of an optical instrument, wherein the optical instrument is preferably a camera and the front side refers to that side on which the camera objective is placed. The front side may be an objective of a camera, or a transparent cover, or protective cover, of such a camera objective, or the like.

### BRIEF DESCRIPTION OF THE DRAWINGS

The invention will be discussed below on the basis of drawings. In the drawings:

FIG. 1 is a perspective view of an optical instrument with a cleaning apparatus in accordance with the present invention;

FIG. 2a is a back view of a cap of the cleaning apparatus in accordance with the present invention;

FIG. 2b is a cross-sectional view of the cap of FIG. 2a taken along line A-A′ in FIG. 2a;

FIG. 2c is a front view of the cap of FIG. 2a;

FIG. 3a is a side view of the cleaning apparatus and of the optical instrument of FIG. 1 in a rest position;

FIG. 3b is a side view of the cleaning apparatus and of the optical instrument of FIG. 1 in a transition position;

FIG. 3c is a side view of the cleaning apparatus and of the optical instrument of FIG. 1 in a cleaning position; and

FIG. 4 is a chart of method steps for cleaning the front of an optical instrument in accordance with the present invention

### DETAILED DESCRIPTION OF THE INVENTION

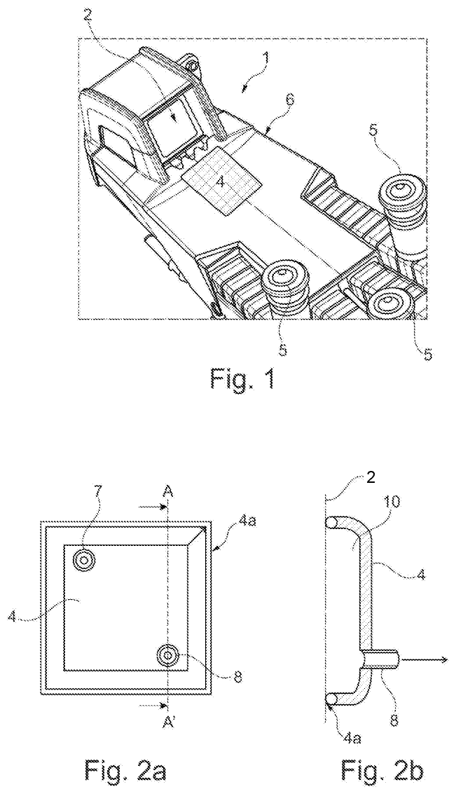

FIG. 1 shows an apparatus 1 for cleaning a front 2 of an optical instrument. The optical instrument is in this case typically any instrument, typically a camera. Here, the objective of the optical instrument, that is to say of the camera, may form the front side, which is to be cleaned, of the optical instrument, or this may be formed by a protective cover of the objective, if present.

In the exemplary embodiment described here, the optical instrument 3 is a camera which is integrated into a milking parlor. The milking parlor is provided and set up for placing the milking cups of the milking equipment of a milking machine onto the teats of the udder of the animal to be milked, such that the milking machine can milk the animal.

For the purpose of placing the milking cups onto the teats of the animal, the milking machine has to know the exact position of the teats. When the animal to be milked, for example a cow, enters the milking parlor, although the approximate position of the animal and the teats is then known, accuracy for automatically attaching milking cups 5 is not sufficient. A sufficiently accurate position of the teats is determined with the aid of the camera 3. Here, the camera 3 produces images of at least the udder and the teats of the animal to be milked and transmits the images produced to a digital signal processing and control means. The latter determines a sufficiently accurate position of the teats of the animal from the images produced by means of digital image processing and transmits this information to the control means of the milking robot or of the milking parlor, so that it can place the milking cups 5 onto the teats.

The optical instrument 3, the camera in this case, is integrated into the milking robot or the milking parlor 6, and is preferably oriented therein such that the udder and the teats of the animal to be milked are imaged from a position below the udder. In one specific embodiment, the optical axis of the optical instrument 3, that is to say of the camera in this case, is tilted upwards from the horizontal through 18°, with the result that the front side of the optical instrument is not vertical, but includes an angle of 108° with respect to a horizontal. For this reason too, dirt which impinges on the front side of the optical instrument, that is to say on an objective, or a corresponding protective cover adheres thereto or leaves marks. Such soiling may be caused for example by steps of the animal to be milked or by spray water.

In the embodiment illustrated here, the front side 2 of the optical instrument 3 has a substantially polygonal shape, whose corners however are preferably not sharp but rounded. In alternative embodiments, the front, which is to be cleaned, of the optical instrument is round, in particular circular.

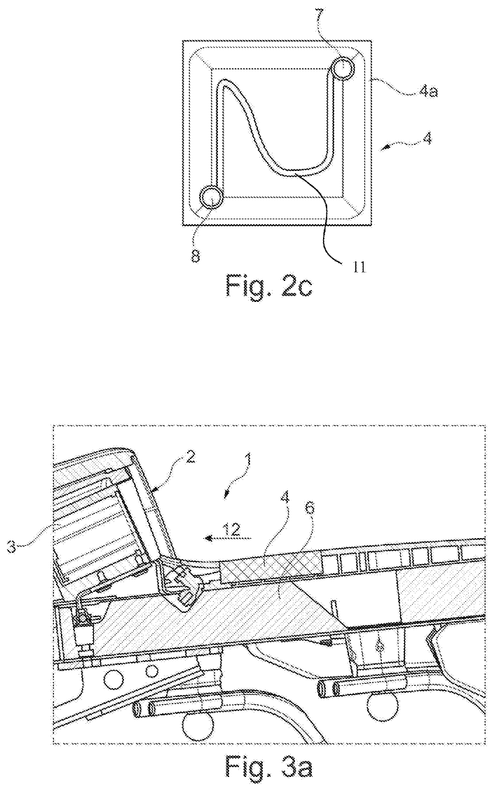

The cleaning of the front side of the instrument 3 is carried out using a cap 4, which is illustrated in FIGS. 2a to 2c. FIG. 2a shows a view of the outer side of the cap 4, FIG. 2b shows a section through the cap along the section plane A-A′, and FIG. 2c shows a view of the inner side of the cap 4, with the inner side being that side which, during the cleaning, faces the front side 2 to be cleaned.

The cap 4 is provided and set up for covering the surface to be cleaned and for realizing fluid-tight closure with the surface to be cleaned. The cap includes an edge region 4a, a fluid feed 7, a fluid discharge, and defines a chamber 10. When the cap 4 is on the front surface 2, the chamber 10 is closed. For this purpose, the cap 4 is of concave form, that is to say curved inwards, wherein the curvature may be not only round but also polygonal. Furthermore, the cap 4 has at least one fluid feed 7 for feeding a cleaning fluid into the chamber 10, and has a fluid discharge 8 for discharging the cleaning fluid from the chamber 10. Here, the cap 4 may have more than one fluid feed and more than one fluid discharge for the feeding and discharge of the cleaning fluid. The feeds and/or discharges may in this case, as illustrated in the figures, be placed on the convex rear side of the cap 4. Alternatively, it is possible for the feeds and discharges to be placed on one or more narrow sides and preferably such that the cleaning fluid, when flowing through the chamber 10, at any rate flows over the relevant regions of the front side to be cleaned and cleans them in the process.

FIG. 2b shows a view of the cap 4 along the section A-A′. A front side to be cleaned is schematically illustrated by the dot-dashed line 2. The cap 4 chamber 10 forms, together with the front side 2, a closed chamber 10 through which cleaning fluid flows.

In order to clean the front side 2 of an optical instrument 3, the cap 4 is mounted or pressed onto the front side 2 to be cleaned such that the chamber 10 is formed and the cap 4 is in fluid-tight closure with the front side 2. For this purpose, the edge region 4a of the cap 4 may be of fluid-tight design. For this purpose, the cap 4 may have, in one embodiment, at least one sealing element along at least a part of the edge 4a. In one embodiment, the cap 4 may for this purpose be pushed or pressed onto the front side 2, which is to be cleaned, of the optical instrument 3, in order to achieve the sealing action in the edge region 4a of the cap 4. As soon as the cap 4 has been placed on the front side 2 of the optical instrument 3 and is held in a fluid-tight manner there, a cleaning fluid is introduced into the chamber 10 via the fluid feed 7 and is discharged via the fluid discharge 8. Preferably, the fluid discharge 8 is subjected to a negative pressure (vacuum) such that the cleaning fluid and soiling loosened therein is discharged from the chamber 10 via the fluid discharge 8. The cleaning fluid, when flowing through the chamber 10, sweeps over the front side 2 of the optical instrument 3. In the process, the cleaning fluid provides loosening action on the front side 2 of the optical instrument 3, and thus cleans said front side 2.

If the cap 4 has been placed on the front 2 to be cleaned, the cleaning fluid is guided into the chamber 10 through the fluid feed 7 and, from there, is guided out of the chamber 10 via the fluid discharge 8, that is to say the outlet opening in the cap 4. Here, the fluid discharge 8 is preferably subjected to a negative pressure (vacuum) such that the cleaning fluid is extracted from the chamber 10 by suction. Here, in a preferred embodiment, the fluid discharge 8 may be subjected to negative pressure (vacuum) before the cleaning fluid is guided via the fluid feed into the chamber 10, so that also, by way of the negative pressure (vacuum), the cap 4 is held firmly on the front side 2 to be cleaned, that is to say the cap 4 adheres there by suction. It is furthermore preferable that the fluid discharge 8 remains subjected to negative pressure (vacuum) after the cleaning fluid has flowed through the chamber 10, and that, if the cleaning fluid is a liquid, a gas, for example air, is also sucked through the chamber 10 in order to remove liquid residues from the front side 2. Alternatively, the front side 2 can dry by itself after the end of the cleaning operation and when the cap 4 has already left the cleaning position.

In an alternative embodiment, it is also possible for the cap 4 to still remain placed on the front 2 to be cleaned after the cleaning operation, in this way it will serve as protection against renewed soiling, for example in the case of manual or machine cleaning of the entire milking parlor. The cap 4 may then remain placed on the front 2 until the optical instrument 3 is needed again.

FIG. 2c shows a view of the curved inner side of the cap 4. The cap 4 may have on the inwardly curved side at least one flow-guiding device 11 which is provided and set up for guiding the flow of the cleaning fluid. In this case, the flow-guiding device 11 is preferably configured such that the flow over the camera front 2 is continuous and no dead angles in terms of flow, where loosened dirt particles can be deposited and accumulate, are formed over the front 2.

In one embodiment, the flow direction may be provided, in particular if the cleaning fluid is a liquid, so as to be directed counter to the gravitational force, in order to avoid the formation of bubbles, and bubbles which possibly form can be extracted via the fluid discharge by suction, with the result that the entire chamber 10 is in a state filled with cleaning fluid in a bubble-free manner.

A flow-guiding device 11 is, in terms of its structural height, preferably configured such that this maintains a minimum spacing to the front side 2, which is to be cleaned, of the optical instrument 3, with the spacing being selected such that typical dirt particles are not jammed on the front side 2 by the flow-guiding device 11, but rather are loosened, and transported away, by the cleaning fluid.

In one embodiment, the cap 4 may be connected to a fluid feed and fluid discharge (not illustrated in the figures) for cleaning fluid such that cleaning fluid is able to flow through the cap if the cap 4 has been placed on a front side 2 to be cleaned. In one embodiment, the fluid feed and discharge may be connected to a cleaning system which is present in the milking parlor, such that concomitant use is made of the cleaning fluid or flushing water which is already present in the milking parlor and which is typically used for cleaning the interior of the milking parlor. Further, in a preferred embodiment, automatic switching between a degreasing cleaning fluid and a descaling cleaning fluid may be utilized. Preferably, the cleaning fluid is selected such that quick and residue-free drying can be realized with any residues on the surface to be cleaned.

The cap 4 may be arranged in the apparatus in a mechanically movable manner, such that the cap 4 can be moved from a rest position into a cleaning position. For this purpose, a corresponding drive is preferably connected to a controller which, at present times or in the case of specific events, activates the drive such that the cap 4 is moved from the rest position into the cleaning position. In this way, the cap 4 may be moved at regular intervals, for example after a predefined period of time has elapsed, into the cleaning position in order, there, to clean the front side 2 of the optical instrument 3. Alternatively, it is possible for the cap 4 to be moved into the cleaning position, and for cleaning to be carried out, in coordination with specific events, for example after a milking operation, when the animal has left the milking parlor, or before the beginning of the milking operation, when the animal is just entering or has just entered the milking parlor.

In one embodiment, the cap 4 is arranged in a pivotable manner. For this purpose, the cap 4 may be arranged on a correspondingly movable arm, with the arm being able to be pivoted from a rest position into a cleaning position in a mechanically driven manner. In one embodiment, the movable arm may be arranged on the milking parlor. In this case, the cap 4 may be placed on the surface 2 to be cleaned until an image has to be produced. As soon as the image has been produced, the cap 4 may be brought into the cleaning position again in order, in this way, to protect the optical instrument during a milking operation. Consequently, the cap 4 is moved from the cleaning position only if an image or multiple successive images is/are produced.

In an alternative embodiment, the cap 4 may be rotatable in an edge region 4a, and mounted in the vicinity of the front side, such that the cap is swung from the rest position into the cleaning position merely by way of a rotational movement.

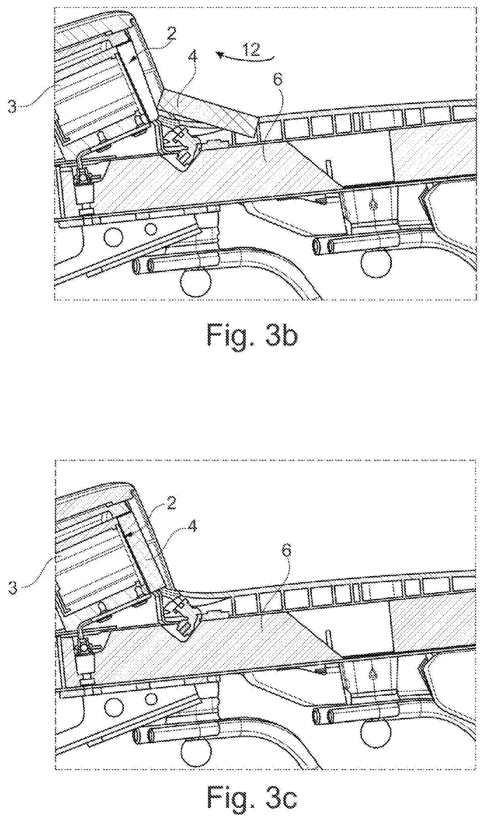

In an alternative, preferred embodiment (see FIGS. 3a-d), the cap 4 is mounted displaceably such that the cap 4 can be moved from a rest position into the cleaning position in a rail-guided manner.

FIG. 3a shows a sectional view through the apparatus 1 illustrated in FIG. 1. The figure shows the cap 4 in the rest position. The front side 2 of the optical instrument 3 is in this case protective glass which has been placed in front of an objective of a camera 3. In the illustrated embodiment, the cap 4 is guided in rails, such that the cap 4 can be moved from the illustrated rest position into the cleaning position in a rail-guided manner, preferably with a translational movement 12 (see in this regard FIGS. 3b-c below). Here, the cap 4 may be moved along the rails from the rest position into the cleaning position by a conventional mechanical drive, for example a motor-driven threaded spindle, or by means of a toothed belt or by means of a hydraulic or pneumatic cylinder. In the rest position, the cap 4 is preferably integrated into the milking parlor such that the cap 4 is protected against damage and soiling, wherein in particular the concave inner side of the cap 4 is protected against soiling.

FIG. 3b shows a state of the apparatus in which the cap 4 is moving in a rail-guided manner from the rest position (see FIG. 3a) into the cleaning position (see FIG. 3c) and in the direction of the arrow 12.

FIG. 3c shows the state of the apparatus in which the cap 4 is positioned in the cleaning position, that is to say on the front 2 of an optical instrument 3, of the camera 3 in this case. In the embodiment illustrated here, the cap 4 completely covers the front 2, which is to be cleaned, of the optical instrument. In alternative embodiments, the apparatus may also be configured such that the covering cap 4 covers a portion of the front 2, to be cleaned, and is moved to other portions to clean the entire front 2.

In one embodiment, the apparatus 1 may be configured such that the fluid feed 7 and the fluid discharge 8, upon attainment of the cleaning position, are automatically connected to a flushing system, which then provides at the fluid discharge a negative pressure (vacuum) for extraction by suction and at the fluid feed a cleaning fluid under pressure. In one embodiment, the automatic connection may be realized in that the connecting pieces of the fluid feed 7 and of the fluid discharge 8 are automatically guided into corresponding receptacles and, there, the connection to the flushing system is realized with sufficient sealing action.

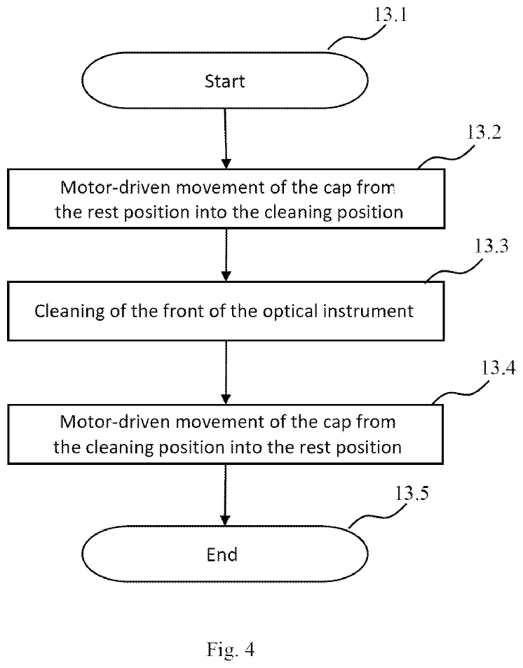

FIG. 4 shows the steps of a method for cleaning a front 2 of an optical instrument 3 using an apparatus 1. After the start (13.1), in the first step 13.2, the cleaning cap 4 is driven mechanically, for example with motor action or hydraulically, in particular with electric motor action, and is moved between the rest position into the cleaning position, wherein the movement of the cap may be a pivoting movement or a rail-guided displacement, for example.

As soon as the cap 4 has reached the cleaning position, the cleaning of the front 2 of the optical instrument (step 13.3) begins, in that the fluid discharge of the cap 4 is subjected to a negative pressure (vacuum) and the cleaning fluid is guided via the fluid feed into the chamber 10. Preferably here, the fluid discharge is subjected to the negative pressure (vacuum) before the cleaning fluid is introduced into the chamber 10. Here, the cleaning fluid is a flushing liquid which is likewise used for flushing of the milking cups or of the milking equipment. In this way, the apparatus 1 does not need a separate device for the supply of cleaning fluid. As soon as the cleaning of the front 2 has been completed, the cap 4 is moved, again in a mechanically driven manner, from the cleaning position back into the rest position (13.4). As soon as the cap has reached the rest position again, the cleaning process ends (13.5).

The apparatus 1 makes possible in this way fully automatic cleaning of the front of an optical instrument, in particular of a camera, or of an associated cover or glazing, by means of a cleaning fluid.

The foregoing is provided to explain the invention to those skilled in the art, and no unnecessary limitations therefrom should be read into the following claims.

1. A milking parlor optical instrument cleaning apparatus comprising:
a moveable cap defining a chamber, and having a fluid feed and a fluid discharge in fluid communication with the chamber, and the cap is moveable to cover at least a portion of a front of a milking parlor optical instrument in a fluid-tight manner and expose the chamber to the front of the milking parlor optical instrument.

2. The milking parlor optical instrument cleaning apparatus of claim 1, wherein the cap is sized to completely cover the front of the milking parlor optical instrument in the cleaning position.

3. The milking parlor optical instrument cleaning apparatus of claim 1, wherein the cap includes a flow-guiding device disposed in the chamber and extending at least partially between the fluid feed and the fluid discharge.

4. The milking parlor optical instrument cleaning apparatus of claim 1, and further comprising:
a cap adjustment device engaged with the cap to move the cap between a rest position and a cleaning position.

5. The milking parlor optical instrument cleaning apparatus of claim 1, and further comprising:
a rail on which the cap is disposed.

6. The milking parlor optical instrument cleaning apparatus of claim 1, wherein the fluid feed is disposed to receive a cleaning liquid.

7. The milking parlor optical instrument cleaning apparatus of claim 1, and further comprising:
a seal disposed on the cup to engage the front of the milking parlor optical instrument in the cleaning position.

8. The milking parlor optical instrument cleaning apparatus of claim 1, wherein the cap remains in the cleaning position during milking of an animal.

9. The milking parlor optical instrument cleaning apparatus of claim 1, wherein the fluid feed and the fluid discharge are in fluid communication via the chamber.

10. A method for cleaning a front of a milking parlor optical instrument with a fluid, the method comprising the steps of:
placing a cap into a cleaning position in which the cap is in fluid-tight engagement with the front of the optical instrument and to expose a chamber defined by the cap to the optical instrument front;
feeding a cleaning fluid into the chamber when the cap is arranged in the cleaning position; and
discharging the cleaning fluid from the chamber.

11. The method of claim 10, and further comprising the step of:
moving the cap between the cleaning position and a rest position.

12. The method of claim 10, and further comprising the step of:
guiding the cleaning fluid from the chamber back into a cleaning apparatus.

13. The method of claim 10, and further comprising the step of:
maintaining the cap in the cleaning position during milking of an animal.
